(19) United States
(12) Patent Application Publication
(10) Pub. No.: US 2025/0287230 A1
(43) Pub. Date: Sep. 11, 2025

(54) TELECOMMUNICATIONS RESOURCE CONNECTIVITY VIA PROACTIVE TELECOMMUNICATIONS NETWORK ERROR DETECTION SYSTEMS AND METHODS

(71) Applicant: T-Mobile USA, Inc., Bellevue, WA (US)

(72) Inventors: Craig M. Loper, Oak Point, TX (US); Boua Lor, Bellevue, WA (US); Ed Barrett Rosen, Black Diamond, WA (US)

(21) Appl. No.: 18/595,908

(22) Filed: Mar. 5, 2024

(51) Int. Cl. H04W 24/04

(52) U.S. Cl. CPC H04W 24/04

(57) ABSTRACT

Systems and methods for improving telecommunications network resource connectivity via proactive telecommunications network error detection are disclosed. The system receives a triggered message indicating a service impact error impacting a quality of service between a user device and a telecommunications network. Responsive to receiving the message, the system accesses a set of connectivity artifacts to determine a set of telecommunications components associated with the service impact error. Responsive to determining the set of telecommunications components associated with the service impact error, the system accesses a subset of the set of connectivity artifacts to identify a cause of the service impact error. The system then determines a set of user devices that communicate with any of the set of telecommunications components during a first time period. The system then transmits a message indicating the cause of the service impact error to each user device of the set of user devices.

### BACKGROUND

A wireless network, such as a cellular network, can include an access node (e.g., base station) servicing multiple wireless devices or user equipment (UE) in a geographical area covered by a radio frequency transmission provided by the access node. As technology has evolved, different carriers within the cellular network have utilized different types of radio access technologies (RATs). RATs can include, for example, 3G RATs (e.g., GSM, CDMA, etc.), 4G RATs (e.g., WiMax, Long Term Evolution (LTE, etc.), or 5G RATs (New Radio (NR)).

Wireless networks may provide one or more telecommunications services. For example, telecommunications services may generally refer to services (e.g., voice, text, data) provided by a telecommunications service provider via a telecommunications network. When using such wireless networks, one or more components of the wireless network (e.g., access nodes, base stations, internal network components) or the UE itself may cause one or more errors that may impact a telecommunications service. While network engineers may be trained to continually monitor, update, and resolve errors that occur on the network side (e.g., components that the telecommunications network service provider directly controls) to ensure UE is able to receive the best possible wireless connectivity services, network engineers may only be alerted of such errors when it is too late, or end users (e.g., of the UE) may experience poor wireless connectivity/poor telecommunications services. Additionally, the sheer complexity of these errors and unknown factors that may cause these errors presents a significant challenge for resolving such errors quickly without a large amount of user's services being negatively impacted. As these errors are not resolved in a timely fashion, users may create a plethora of service impact notifications to be sent to the telecommunications service provider to resolve their issues, thereby causing a large increase in network traffic as such service impact notifications are transmitted over the wireless network for resolution. These and other drawbacks exist.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a flowchart illustrating a process for improving telecommunications network resource connectivity via proactive telecommunications network error detection, in accordance with one or more implementations of the present technology.

FIG. 4 is a block diagram of an artificial intelligence model, in accordance with some implementations of the present technology.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Service impact errors generally refer to errors that impact or otherwise disrupt telecommunications services provided to UE (e.g., user equipment, user devices, mobile devices, etc.) from a telecommunications network. For example, such service impact errors negatively impact wireless telecommunications services such as text, voice, data, or other services. As technology has evolved, wireless telecommunications networks and services are relied upon more and more each day to provide the fastest and most reliable telecommunications service to UE. This standard is of the highest priority when potential customers decide to choose a telecommunications service provider. Such standard has been long maintained due to network engineers, computer scientists, and others careful analysis of telecommunications components and the UE themselves to ensure that no malfunctioning components or UE may disrupt wireless telecommunications services to the masses.

However, ensuring that a telecommunications network is error free is an arduous, cumbersome, and resource-intensive task that relies upon one or more notifications/messages generated by users that are currently experiencing a service impact error/issue. For example, when an end user (e.g., a mobile user of the telecommunications network) experiences a service impact error (e.g., a dropped call, no service, slow internet), the user may transmit a notification, message, email, ticket, or phone call to the telecommunications service provider to alert the service provider of the error and to quickly resolve the error. Such an error may not just be limited to one user of the telecommunications network, but also may be experienced by a large number of other users as such errors may be the result of a telecommunications network component (e.g., base station) malfunction. As such, a large amount of users may be impacted by the service impact error, and may be ignited to generate their own notification to the telecommunications service provider—thereby wasting valuable telecommunications resources (e.g., bandwidth) that may otherwise be conserved to provide the best wireless connectivity services to users. As such, existing systems currently do not have a mechanism to proactively detect service impact errors in real time without user intervention, which further causes a poor quality of service experienced by users of a given telecommunications network, as such errors go unnoticed until experienced by one or more users.

Further, to resolve such errors, albeit, subsequent to a poor quality of service being experienced by users, existing systems rely on manually analyzing telecommunications components (e.g., physical base station visits, analyzing log messages from base stations or other components, etc.) to determine a cause of the service impact error and then resolve the service impact error. However, due to the sheer volume of information to consider as there may be hundreds of thousands, if not millions, of telecommunications components to analyze, network engineers may miss or otherwise overlook a potential cause to the error. Moreover, as each service impact error may be unique to a particular device, or may not be unique to a given device (e.g., may be widespread across the network), a multiplicity of unknown factors may be involved to determine the cause of the service impact error. For example, while network engineers may analyze log messages of telecommunications network components, valuable on-device information of the UE may be unavailable, limiting any such analyzation of service impact errors and the causes thereof. Without a mechanism to narrow down a given cause of a service impact error by reducing the amount of information to analyze, existing systems lack the ability to accurately and efficiently determine/resolve service impact errors.

In light of these and other problems with existing solutions and systems, there is a need for improving telecommunications network resource connectivity. Furthermore, there is a need to proactively detect telecommunications network errors in real time (or near-real time). Additionally, there is a need to reduce the amount of information required to analyze by identifying and utilizing subsets of error-associated data. Moreover, there is a need to reliably and efficiently identify which components of a telecommunications network are associated with a service impact error. There is also a need to effectively and efficiently resolve telecommunications service impact errors based on a type of the service impact error.

The inventors have developed a system for improving telecommunications network resource connectivity. For example, the inventors have developed a unique proactive telecommunications network error detection system that improves telecommunication network resource connectivity. The inventors have further developed a system for reducing computational resource usage involved in determining causes of telecommunication network errors (e.g., service impact errors) by reducing connectivity artifact data to a subset of connectivity artifact data, thereby analyzing smaller datasets as opposed to those used by existing systems. Moreover, the inventors have developed a proactive system to (i) notify impacted users and (ii) resolve service impact errors of the impacted users prior to such users experiencing service impact errors, thereby improving telecommunications network resource connectivity via proactive telecommunications network error detection.

The disclosed system can receive a triggering message indicating a service impact error impacting a quality of service between a user device and a telecommunications network. For example, the system may receive an automatically generated and triggered notification from a telecommunications network component (e.g., a base station) which can include an identifier of a mobile device and a service impact error identifier. By receiving an automatically triggered message as opposed to relying on user-generated notifications, the system can proactively detect telecommunications service impact errors to trigger network error diagnostic processes, thereby enhancing telecommunications resource connectivity.

Responsive to receiving the notification, the system can access a set of connectivity artifacts (e.g., log messages, event tracing messages, monitoring data) to determine a set of telecommunications components associated with the service impact error. For example, the system may determine which telecommunications components (e.g., base stations, computing components of the telecommunications network, or other components) are associated with the service impact error. For instance, the system may determine which telecommunications components interacted with a mobile device that was identified in the service impact error. In this way, the system narrows a potential cause of the service impact error to a set of telecommunications components, thereby conserving valuable computational resources involved in determining a cause of the service impact error via a reduction in an amount of information to analyze.

The system can then access a subset of the set of connectivity artifacts to identify a cause of the service impact error. As the system has narrowed down potential causes to the service impact error to a set of telecommunications components, the system can determine, using the subset of the connectivity artifacts, the cause of the service impact error. For instance, the cause of the service impact error may be that a base station is offline for maintenance, a given server has failed, another cause, or a combination thereof, that leads to an impact in telecommunications services.

The system may then determine a set of user devices that have/will communicate with any of the determined set of telecommunications components using the subset of the set of connectivity artifacts. For example, the system may identify which mobile devices have interacted with or regularly interact with the telecommunications components that are associated with the service impact error by using the subset of connectivity artifacts. By doing so, the system reduces the amount of computational resources (e.g., computer processing and memory resources) by further reducing the amount of information to analyze when determining a cause of the service impact error. The system can then transmit a message indicating the cause of the service impact error to each user device of the set of user devices to proactively alert users of service impact errors.

Moreover, the system can deploy one or more network resources to correct service impact errors based on the type of cause. For instance, the system can update one or more telecommunications components (e.g., servers, base station components, etc.) to resolve the service impact error. By doing so, the system may correct or otherwise resolve service impact errors in real time (or near-real time) prior to other user devices experiencing the service impact error—thereby enhancing telecommunications network resource connectivity.

In various implementations, the methods and systems described herein can improve telecommunications network resource connectivity via proactive telecommunications network error detection. For example, the system can receive a triggered message indicating a service impact error impacting a quality of service between a user device and a telecommunications network, where the message includes (i) a user device identifier and (ii) a service impact error identifier. Responsive to receiving the message indicating the service impact error, the system accesses a set of connectivity artifacts to determine a set of telecommunications components associated with the service impact error using the triggered message. Responsive to determining the set of telecommunications components associated with the service impact error, the system accesses a subset of the set of connectivity artifacts to identify a cause of the service impact error. Using the subset of the set of connectivity artifacts, the system determines a set of user devices that communicate with any of the set of telecommunications components during a first time period. The system can then transmit a message indicating the cause of the service impact error to each user device of the set of user devices.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

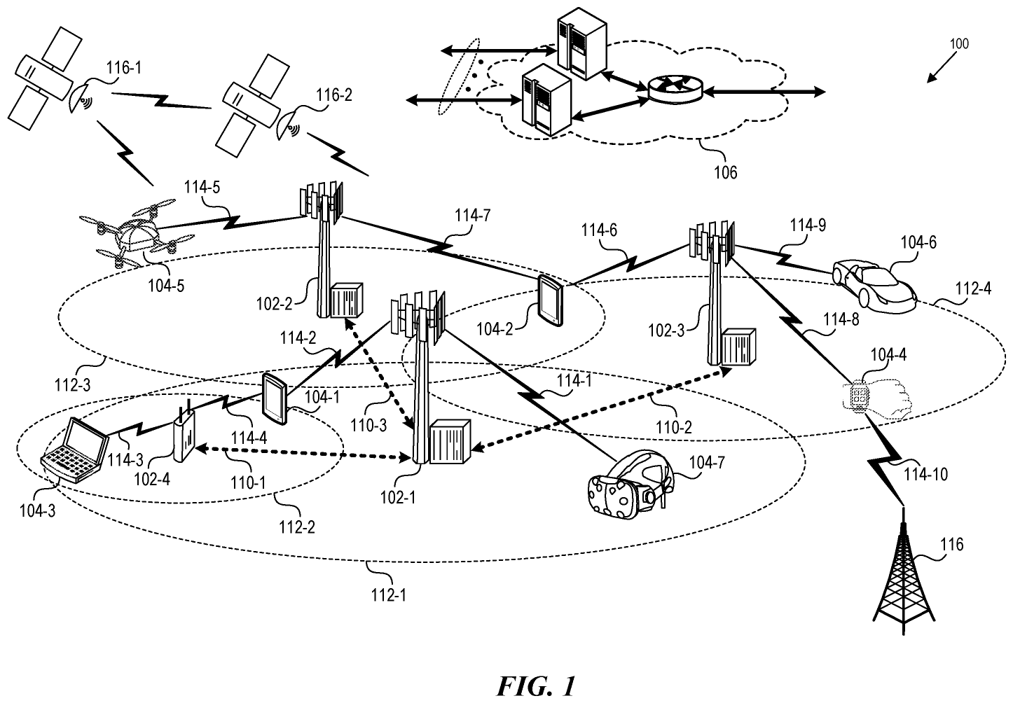

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, a radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links 132 (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of the network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A terrestrial network is enabled through the base stations 102 or antenna 116. A 6G implementation of the network 100 can support terahertz (THz) communications. This can support wireless applications that demand ultrahigh quality of service (QOS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

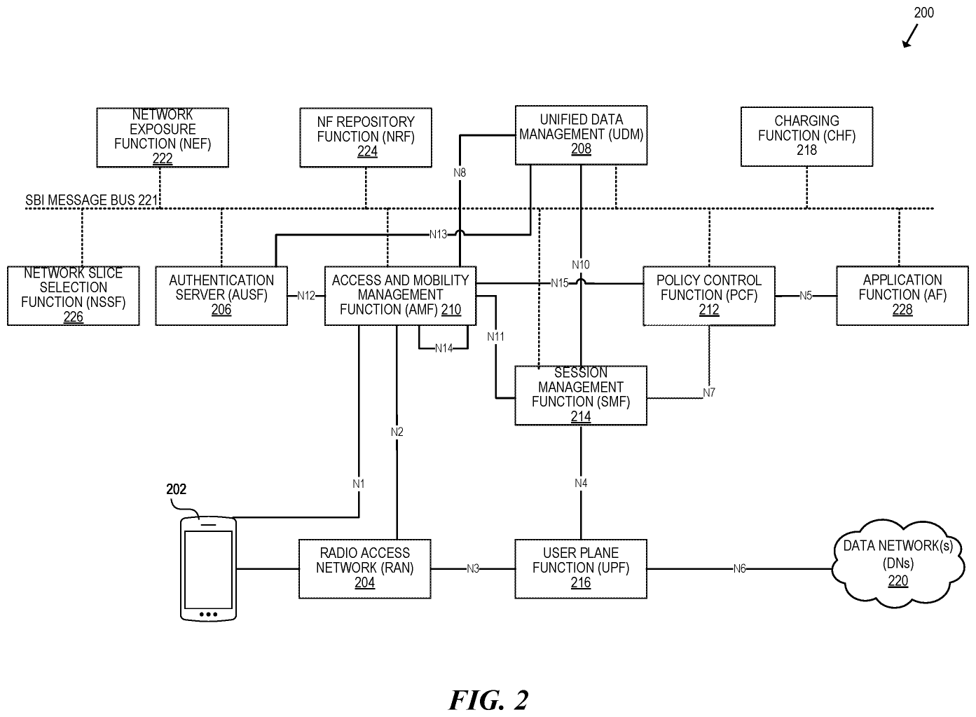

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNS) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

In some implementations, the AF 228 can include one or more applications that can detect service impact errors (e.g., quality of service errors). For instance, the AF 228 may detect quality of service related metrics, such as when a call is dropped, data latency values, data packet loss values, round-trip times, one way delay times, packet jitter, packet delay variation, bandwidth values, network capacity values, error rates, end-to-end delays, voice call quality, or other quality of service related metrics. Each quality of service related metrics can be associated with a threshold value such that when a quality of service metric satisfies a respective threshold value condition (e.g., meets or exceeds the threshold value, fails to meet or exceed the threshold value), AF 228 may detect a service impact error of the given domain (e.g., related to the respective quality of service metric, corresponding quality of service metric, etc.). In this way, AF 228 may proactively monitor for service impact errors without user intervention.

### Improving Telecommunications Transcription Securitiy

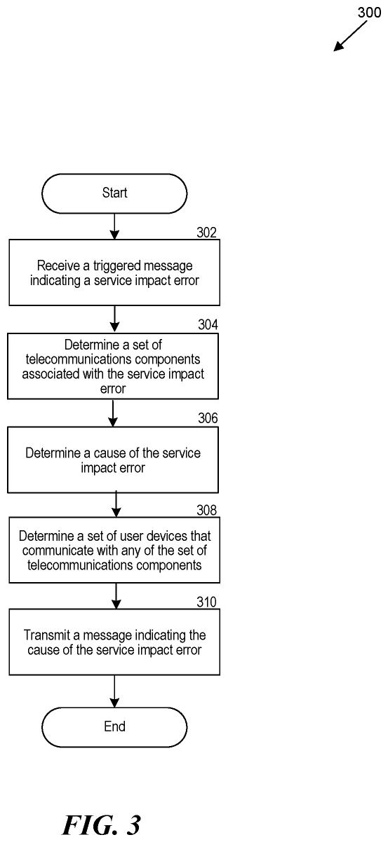

FIG. 3 is a flowchart illustrating a process 300 for improving telecommunications network resource connectivity via proactive telecommunications network error detection, in accordance with one or more implementations of the present technology.

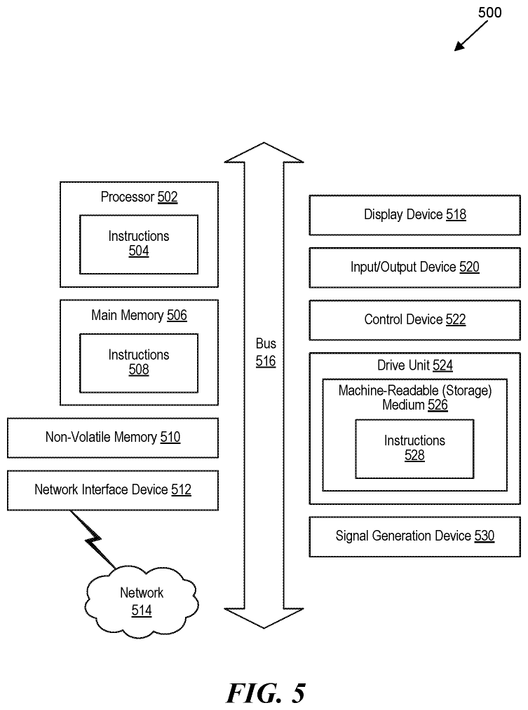

At act 302, process 300 receives a message. For example, the system (e.g., process 300, implemented by one or more components of FIG. 1, FIG. 2, or FIG. 5) can receive a message indicating a service impact error. The message may indicate a service impact error impacting a QoS between a user device and a telecommunications network. The message can include a user device identifier (e.g., a phone number of the user device, a user device serial number, an international mobile equipment identity (IMEI) of the user device, or other identifier), a service impact error identifier (e.g., a value, string, alphanumeric string, code, or other identifier that identifies a service impact error), or other information.

The received message may be automatically triggered. For example, in response to a mobile device detecting that it has disconnected from a base station (e.g., a dropped call, or otherwise lost connectivity), the mobile device may transmit a message to a base station indicating the dropped call. As another example, in response to the telecommunications network detecting it has disconnected from the mobile device, the base station (or other network components) may transmit the message to the system indicating the telecommunications network error. As yet another example, the message (e.g., triggered message) can be a customer service ticket (e.g., provided by the user of the user device) that indicates a service impact error (e.g., dropped call, loss of connectivity, low network speeds, high latency, etc.) or other network-related error. In this way, the system can proactively detect network-related issues in real time (and correct such errors in real time), thereby improving telecommunications network resource connectivity.

In some implementations, the message can be received from the user device. For example, the user device (e.g., a mobile device, a cellular device, smart phone, tablet computer, laptop, satellite device) can detect that the service impact error is relative to at least one telecommunications components of the set of telecommunications components, and can trigger the generation of the message indicating the service impact error. For example, during a communication session, the user device (e.g., a mobile device) can communicate with one or more other user devices via the telecommunications network (e.g., using one or more telecommunications components of the telecommunications network).

During the communication session, the user device may detect a service impact error (e.g., a dropped call, low data latency, loss of service, etc.) relative to at least one of the telecommunications components. For instance, where the service impact error is a dropped call, the user device may detect that the user device experienced a dropped call when communicating with a given base station. In response to experiencing the dropped call, the user device can generate a message indicating a service impact error (e.g., indicating a dropped call at a given base station), and can transmit the message to the telecommunications network indicating the service impact error. In this way, the system may proactively monitor for service impact errors by receiving automatically triggered service impact messages.

In other implementations, the message may be received in response to a given telecommunications component of the set of telecommunications components that the user device was communicating with detecting the service impact error. Continuing with the example above, as opposed to the user device detecting the service impact error (e.g., a dropped call), a logical component with the base station (e.g., AF 228 (FIG. 2)) may detect that a call was dropped when communicating with the user device. In response to detecting the dropped call, the system can generate the message indicating the service impact error, and can transmit the message to the AF 228 (FIG. 2). In this way, the system may accurately detect service impact errors in real time without the reliance of a user device detecting the service impact error—thereby providing a more robust and faster response time to detecting service impact errors.

In some implementations, the message can be generated in connection with a quality criterion. For example, the system can detect that a quality criterion associated with a communication session associated with the user device and the telecommunications network (e.g., via the one or more telecommunications components) fails to satisfy a threshold quality criterion. The quality criterion can be any QoS criterion such as latency, jitter, jitter buffer discard rate, packet loss, or other quality criterion. The threshold quality criterion can correspond to the quality criterion, such as a threshold latency time period (e.g., 5 milliseconds, 100 milliseconds, 150 milliseconds), a threshold jitter rate (e.g., 20milliseconds, 30 milliseconds, 40 milliseconds, etc.), a threshold value rate (e.g., percentage, ratio, decimal, etc.) of a jitter buffer discard rate, a threshold amount of packets, or other threshold quality criterion. In some implementations, the system may determine that the quality criterion of the communication session fails to satisfy the threshold quality criterion when the quality criterion meets or exceed the threshold quality criterion. For example, where the quality criterion is of communication session latency indicating 200 milliseconds, and the threshold quality criterion is 150 milliseconds, the system may determine that the quality criterion fails to satisfy the threshold quality criterion (e.g., indicating a low quality call or communication session).

Responsive to detecting that the quality criterion fails to satisfy the threshold quality criterion, the system can trigger the generation of the message. For example, at least one of the telecommunications components (e.g., a logical component, such as AF 228 (FIG. 2)) can detect that the quality criterion fails to satisfy a corresponding threshold criterion. For instance, the logical component may monitor quality criterion associated with a communications session between the user device and a base station. Responsive to detecting that a quality criterion (e.g., latency) fails to satisfy a 10 millisecond threshold latency value, the logical component may generate the triggered message indicating the service impact error. Additionally or alternatively, the system can cause the access of the connectivity artifacts to determine the set of telecommunications components associated with the service impact error. In this way, the system may enhance the speed at which service impact errors are identified (e.g., via in network detection). Additionally, in this way, the system may proactively identify service impact errors before they occur. For example, as high latency may lead to a dropped call, by using a QoS criterion, the system can identify and rectify service impact issues before such service impact errors become more severe.

At act 304, process 300 can determine a set of telecommunications components associated with the service impact error. For example, in response to receiving the message indicating the service impact error impacting the QoS between the user device and the telecommunications network, the system accesses a set of connectivity artifacts to determine a set of telecommunications components associated with the telecommunications service impact error using the message (e.g., triggered message). The triggered message may use the user device identifier and the service impact error identifier to parse through a set of connectivity artifacts for a match.

The connectivity artifacts may be related to one or more telecommunications components (e.g., of FIG. 1 and FIG. 2.). For instance, each telecommunication component may log data (e.g., log files, messages, or other artifacts) when events occur, such as when accounts are provisioned, when mobile devices connect to the network, QoS data (e.g., network speeds, latency, connection statuses), base stations under maintenance, dropped calls, network error data, or other information associated with telecommunications systems. Such log data can include user device identifiers (e.g., IMEI numbers, serial numbers, phone numbers, etc.), network error identifiers (e.g., an identifier indicating that an error has occurred, a type of error (network or provisioning error), a specific error (loss of connection, failure to transmit requests, failed update, and so on)), or other information. As another example, such connectivity messages may be associated with network logs, service logs, registration logs, cellular network logs, WIFI logs, Internet Protocol Multimedia Subsystem (IMS) logs, registration service logs (GSM, UMTS, LTE, 5G, WiFi, etc.), or other logged information.

The system may parse the connectivity artifacts to determine a set of telecommunications components associated with the service impact error using the message. For example, the system may initially parse the available connectivity artifacts to identify artifacts that indicate (i) the user device identifier or (ii) the service impact error identifier. To reduce the amount of computational resources associated with parsing through the available connectivity artifacts, the system can further parse the set of connectivity artifacts with respect to a first time period. For example, the first time period may be a predetermined time period (e.g., 1 minute, 5 minutes, 10 minutes, 30 minutes, 1 hour, 2 hours, 3 hours, etc.). As another example, the first time period can be a dynamic time period that is based on the time at which the message was received. For instance, where the first time period is a dynamic time period, the system may parse the connectivity artifacts that are within 30 minutes of receiving the message. In this way, the system may reduce the amount of computational resources conventionally required to parse through a large amount of connectivity artifacts.

The system can determine the set of telecommunications components associated with the service impact error by first identifying which connectivity artifacts indicate the user device identifier or the network error identifier. Upon identifying the connectivity artifacts indicating the user device identifier or the service impact identifier, the system may parse the identified connectivity artifacts for a telecommunications component identifier.

The telecommunications component identifier may be any identifier that identifies a telecommunications component of FIG. 1 or FIG. 2. For example, such telecommunications component identifiers may include a value, integer, alphanumeric string, a string, a serial number, a software version identifier, a component name, or other identifier. The system may extract, from each connectivity artifact of the identified set of connectivity artifacts, the telecommunications component identifier to determine the set of telecommunications components associated with the service impact error using the message. In this way, the system may identify which telecommunications component (e.g., base stations, satellites, user equipment, network servers, cell towers, cell antenna) is associated with the service impact error to be used when identifying a cause of the service impact error—thereby reducing the pool of potential causes of the service impact error, which may further lead to a reduction in the amount of computational resources needed to identify a cause of the service impact error.

At act 306, process 300 can determine a cause of the service impact error. For example, responsive to determining the set of telecommunications component associated with the service impact error, the system can access a subset of the set of connectivity artifacts to identify a cause of the service impact error. The system may parse the set of connectivity artifacts to generate a subset of the set of connectivity artifacts. For example, the subset of the set of connectivity artifacts can be connectivity artifacts that are related to each telecommunications component of the set of telecommunications components. The system may parse through the set of connectivity artifacts using an identifier associated with, or included within the connectivity artifacts to identify a match between (i) a telecommunications component identifier of the set of telecommunications components and (ii) a telecommunications component identifier that is associated with or included within the connectivity artifacts. That is, the system may compare the telecommunications component identifiers of each telecommunications component of the set of determined telecommunications components (e.g., that are associated with the service impact error) to each telecommunications component identifier included within the set of connectivity artifacts. Upon determining a match, the system may extract the respective connectivity artifact to generate the subset of the set of connectivity artifacts. In this way, the system may filter the set of connectivity artifacts to a subset, thereby reducing the amount of computational resources required to determine (or identify) a cause of the service impact error.

Using the subset of the set of connectivity artifacts, the system may determine (or otherwise identify) a cause of the service impact error. For example, the connectivity artifacts can include information that indicates a cause of the service impact error (e.g., account provisioning details, network failure information, network error information, device related information, software information, or other information indicative of an error). The information indicating the cause of the service impact error may include one or more codes, predetermined strings, error identifiers, or other service impact error identifying information. The system may extract the service impact error identifying information from the subset of connectivity artifacts and compare the service impact identifying information to a set of predetermined service impact identifying information (e.g., via a database associated with AF 228 (FIG. 2)) to determine the cause of the service impact error.

In some implementations, the system can use a machine learning model to determine a cause of the service impact error. For example, the system can provide the set of connectivity artifacts to a machine learning model configured to generate a cause of the service impact error. Responsive to providing the set of connectivity artifacts to the machine learning model, the machine learning model can generate the cause of the service impact error. The cause of the service impact error can indicate (i) a type of cause of the service impact error (e.g., a network type cause, a user device type cause, etc.), or (ii) a telecommunications component of the set of telecommunications components that caused the service impact error. In this way, the system can identify the cause of the service impact error more accurately as the machine learning model may determine relationships and trends in the set of connectivity artifacts that humans or other parsing algorithms are unable to ascertain.

For example, the machine learning model can be an artificial intelligence model, a deep learning model, a neural network, a convolutional neural network, a recurrent neural network, a support vector machine, a natural language processing model, KNN model, a linear regression model, a logistic regression model, a random forest model, a Bayesian model, or other artificial intelligence/machine learning model. The machine learning model may be pre-trained and accessed via a machine learning model database (e.g., associated with AF 228 (FIG. 2)). Additionally or alternatively, the machine learning model may be trained using training data stored in a database (e.g., stored in a database in association with AF 228 (FIG. 2)).

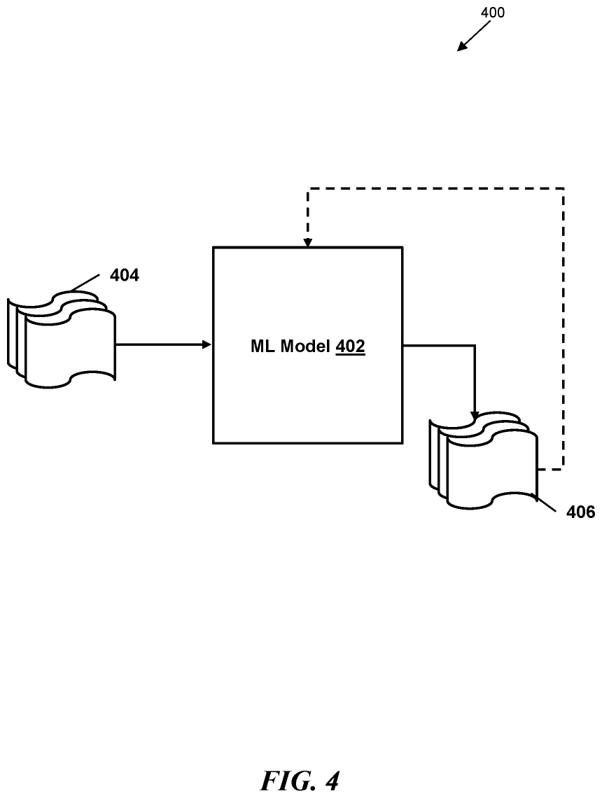

Referring to FIG. 4, which shows a block diagram of an artificial intelligence model, in accordance with some implementations of the present technology, the system may use model 402 to determine a cause of the service impact error. Model 402 may take inputs 404 and provide outputs 406. The inputs may include multiple datasets, such as a training dataset and a test dataset. Each of the plurality of datasets (e.g., inputs 404) may include data subsets related to user data, predicted forecasts and/or errors, and/or actual forecasts and/or errors. In some implementations, outputs 406 may be fed back to model 402 as input to train model 402 (e.g., alone or in conjunction with user indications of the accuracy of outputs 406, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., the cause of the service impact error).

In a variety of implementations, model 402 may update its configurations (e.g., weights, biases, or other parameters) based on the assessment of its prediction (e.g., outputs 406) and reference feedback information (e.g., user indication of accuracy, reference labels, or other information). In a variety of implementations, where model 402 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 402 may be trained to generate better predictions.

In some implementations, model 402 may include an artificial neural network. In such implementations, model 402 may include an input layer and one or more hidden layers. Each neural unit of model 402 may be connected with many other neural units of model 402. Such connections can be enforcing or inhibitory in their effect on the activation state of connected neural units. In some implementations, each individual neural unit may have a summation function that combines the values of all of its inputs. In some implementations, each connection (or the neural unit itself) may have a threshold function such that the signal must surpass it before it propagates to other neural units. Model 402 may be self-learning and trained, rather than explicitly programmed, and can perform significantly better in certain areas of problem solving, as compared to traditional computer programs. During training, an output layer of model 402 may correspond to a classification of model 402, and an input known to correspond to that classification may be input into an input layer of model 402 during training. During testing, an input without a known classification may be input into the input layer, and a determined classification may be output.

In some implementations, model 402 may include multiple layers (e.g., where a signal path traverses from front layers to back layers). In some implementations, back propagation techniques may be utilized by model 402 where forward stimulation is used to reset weights on the “front” neural units. In some implementations, stimulation and inhibition for model 402 may be more free-flowing, with connections interacting in a more chaotic and complex fashion. During testing, an output layer of model 402 may indicate whether or not a given input corresponds to a classification of model 402 (e.g., a response to a user provided query).

In some implementations, the model (e.g., model 402) may automatically perform actions based on outputs 406. In some implementations, the model (e.g., model 402) may not perform any actions. The output of the model (e.g., model 402) may indicate or otherwise be used to identify a cause of the service impact error, indicate one or more network resources to be deployed to resolve or fix the service impact error, or other information, in accordance with one or more implementations of the present technology.

In some implementations, the model (e.g., model 402) can be trained based on training information. Model 402 can take a first set of training information in as input 404 (e.g., connectivity artifacts, telecommunications component identifiers, service impact errors, or other information), and generate an output (e.g., one or more causes of the service impact error) as output 406. For example, model 402 may learn associations between the first set of training information to generate a cause of the service impact error as output 406. In some implementations, outputs 406 may be fed back into the model 402 to update one or more configurations (e.g., weights, biases, or other parameters) based on its assessment of its prediction (e.g., outputs 406) and reference feedback information (e.g., user indication of accuracy, reference labels, ground truth information, known recommendations, etc.). The first set of training information may be historical training information that has been used to train prior artificial intelligence/machine learning models to generate a given cause of a service impact error. In this way, model 402 may be trained to generate one or more causes of service impact errors, thereby enabling accurate and robust generation of service impact error causes that the human mind is unable to ascertain.

Referring back to FIG. 3, at act 308, process 300 can determine a set of user devices. For example, the system can determine a set of user devices that communicate (e.g., have communicated, will communicate) with any of the set of telecommunications components using the subset of the set of connectivity artifacts. The system may determine the set of user devices that communicate with any of the set of telecommunications components during a first time period. For example, the first time period may be a predetermined time period (e.g., five minutes, 10 minutes, 30 minutes, one hour, two hours, 12 hours, one day, 2 days, one week, one month, one year). The predetermined time period may be respective to when the service impact error was received.

For example, where the service impact error was received on Dec. 15, 2023, at 5:00 p.m. ET, and the predetermined time period is 30 minutes, the system may determine the set of user devices that will communicate with any of the identified set of telecommunications components (e.g., base stations, etc.) from Dec. 15, 2023, 5:00 p.m. ET to Dec. 15, 2023, 5:30 p.m. ET. Such determination may be based on a historical frequency to which a given user device communicates with one or more telecommunications components of the set of telecommunications components (e.g., identified in act 304). In this way, the system may determine which user devices are prone to communicate with one or more telecommunications components to which a service impact error is associated with.

As another example, where the service impact error was received on Dec. 16, 2023, at 5:00 p.m. ET, and the predetermined time period is 30 minutes, the system may determine the set of user devices that have communicated with any of the identified set of telecommunications components (e.g., base stations, etc.) from Dec. 15, 2023, 4:30 pm ET to Dec. 16, 2023, 5:00 pm ET. Such determination may be based on parsing through the subset of connectivity artifacts and extracting user device identifiers included therein. In this way, the system may determine which user devices have communicated with one or more telecommunications components to which a service impact error is associated with.

In some implementations, the system can deploy one or more network resources to correct the service impact error based on a type of cause. For example, the system may determine the cause of the service impact error is a network type cause using the subset of the set of connectivity artifacts. A network type cause may be any cause to which the network side (e.g., the telecommunications network, the telecommunications service provider, telecommunications components, etc.) is responsible for causing the service impact error. For instance, a network type cause may refer to any “cause” of the service impact error that is not user device, or user equipment related. For example, the network type cause may be a base station power failure, a site offline for maintenance, a computer server associated with the telecommunications network being offline, or other telecommunications component part of FIG. 1 or FIG. 2. (e.g., core network 106, base station 102, satellite 116-1 (FIG. 1), NEF 222, UPF 216, PCF 212, AMF 210, AUSF 206 (FIG. 2), etc.).

In some implementations, the system can determine that the cause of the service impact error is a network type cause by parsing the subset of the set of connectivity artifacts for a telecommunications component identifier. For example, the subset of connectivity artifacts may include identifiers associated with a given telecommunications component (e.g., a base station, a network architecture component, antenna, servers, IMS core, etc.). The system can parse the connectivity artifacts to determine which telecommunications component is involved with the service impact error. When the system determines which telecommunications components are involved with the service impact error, the system may determine via natural language processing, whether the telecommunications artifact indicates contextual information related to a cause of the error. For example, where the identified telecommunications component (e.g., via the artifact) is a base station, the system may perform natural language processing on the artifact (e.g., connectivity log) to determine whether there is information that indicates that the base station was offline, shut down, powered down, or other reason. When the system determines that there is information indicative of the telecommunications component being the cause of the service impact error, the system may determine that the service impact error is a network type cause.

In some implementations, in response to determining that the cause of the service impact error is a network type cause, the system can deploy one or more network resources to correct the service impact error. For example, the one or more network resources can be resources that the telecommunications network or the telecommunications network service provider can provide that may enhance telecommunications service connectivity. For example, the one or more telecommunications network resources can be a telecommunications network antenna (e.g., a cellular-network antenna, a satellite for satellite communications), a telecommunications network service location (e.g., a cellular-carrier store, a cellular-carrier support center, a cellular-carrier repair store, a satellite communications store, a satellite-carrier support center, etc.), a telecommunications network site (e.g., a cell site, a satellite site), an update to one or more software/hardware components of the telecommunications network, or other telecommunications network resources. For example, where the service impact error is a network type cause stemming from the AUSF 206 software being out of date, the system may update the software associated with the AUSF 206. As another example, where the service impact error is a network type cause, and the identified network component is a base station (e.g., that cause the service impact error), the system can deploy a software update to the base station to correct the service impact error. As yet another example, the system can deploy a maintenance team to the base station to replace hardware associated with the base station to correct the service impact error.

In some implementations, responsive to correcting the service impact error, the system can transmit a message to each user device of the set of user devices indicating that the service impact error is corrected. For example, as each user device has been identified (e.g., act 308), the system can generate a message indicating (i) the service impact error and (ii) that the service impact error is corrected. The system may then transmit, to each user device of the set of user devices, the message to notify the users of the set of user devices, that the service impact error is corrected. In this way, users can be notified of service interruptions, impacts, or other issues before they become more severe.

As another example, where the service impact error is caused in response to a scheduled maintenance of a telecommunications component, the system can proactively alert users of scheduled maintenance and proactively reassign a home base stations to other nearby base stations for the duration of the time to which the base station is under maintenance. For example, the system can identify each user device of the set of user devices that communicate with the base station regularly (e.g., within a threshold amount of time, to which the base station is deemed as a home base station, etc.). The system can then reassign each user device's home station to another base station that is located within a threshold distance of (i) the home base station or (ii) the user device. In this way, users will not experience a telecommunications service disruption when the identified base station is under maintenance, thereby improving telecommunication connectivity. In some implementations, after the threshold time period has expired, the system may reassign the home base station of the user devices back to the original home base stations, thereby improving connectivity (e.g., as the closer a user device is to a base station, the better signal they have).

In some implementations, the system may determine that the cause of the service impact error is a user device type cause using the subset of connectivity artifacts. A user device type cause may refer to any “user device” side cause of the service impact error. For instance, as opposed to the network type cause, as explained above, the user device type cause may be any cause to which the user device is responsible for having caused. As an example, the service impact error may be a user device type cause where the user device powered off suddenly during a call. As another example, the service impact error may be a user device type cause where a communication component internal to the user device has failed (e.g., an antenna, a subscriber identity module (SIM) being out of date, a modem, etc.). As yet another example, the service impact error may be a user device type cause where the telecommunications account that is associated with the user device is not up to date (e.g., with payments, with connectivity settings, provisioning related issue, etc.).

n some implementations, the system can determine that the cause of the service impact error is a user device type cause by parsing the subset of the set of connectivity artifacts for telecommunications component identifiers. The system can parse the connectivity artifacts to determine which telecommunications component is involved with the service impact error. When the system determines which telecommunications components are involved with the service impact error, the system may determine via natural language processing, whether the telecommunications artifact indicates contextual information related to a cause of the error. For example, where the identified telecommunications component (e.g., via the artifact) is a base station, the system may perform natural language processing on the artifact (e.g., connectivity log) to determine whether there is information that indicates that the base station was offline, shut down, powered down, or other reason. When the system determines that there is information indicative of the telecommunications component being the cause of the service impact error, the system may determine that the service impact error is a network type cause. However, if there is no information indicating that the telecommunications component is the cause of the service impact error, the system may determine that the service impact error is a user device type cause.

Additionally or alternatively, the system can determine that the cause of the service impact error is a user device type cause by providing a request to the user device. For example, the request may be a request for user device information pertaining to the telecommunications network, such as device information (e.g., IMEI, device model/manufacturer, operating system version, etc.), network settings (e.g., network operator, network type (e.g., 2G, 3G, 4G, 5G, 6G), roaming status), connection status (e.g., WiFi information (e.g., service set identifier (SSID), signal strength, security settings)), location settings (e.g., GPS status enabled/disabled), SIM card information (e.g., active, inactive, IMSI number, etc.). When the user device receives the request, the user device may automatically provide the requested information back to the system in a response. The system can then determine, based on the response, whether the requested information is in accordance with the latest update settings that are used by the telecommunications network to provide a service to the user device.

For example, the latest update settings may be a set of information that user devices that are connected to the telecommunications network need to receive data from the telecommunications network. As an example, the telecommunications network may require a given user device has a mobile data status that is enabled to receive data from the telecommunications network. The system can access (e.g., in a database) such latest update settings to compare to the received response. When the system determines a match (or via natural language processing), the system can determine that the user device is in accordance with the latest update settings. For example, where the response indicates that the mobile data status is enabled on the user device, and the latest update settings indicate that the mobile data status must be enabled, the system can determine that the user device is in accordance with the latest update settings. As another example, where the response indicates that the mobile data status is disabled, and the latest update settings indicate that the mobile data status must be enabled, the system can determine that the user device is not in accordance with the latest update settings, thereby indicating that the service impact error is a user device type cause. In this way, the system can proactively detect user device type service impact errors.

Responsive to determining that the cause of the service impact error is the user device type cause, the system transmits a second message indicating an update instruction to the user device to cause an update at the user device. For example, continuing with the example above, where the response indicates that the mobile data status of the user device is disabled, the system can transmit a message to the user device to proactively update the settings of the user device remotely (e.g., to enable the mobile data status), thereby correcting the service impact error. As another example, where the connectivity artifact indicates that the service impact error is a user device type cause (e.g., indicating a network security setting of the user device is out of date), the system can provide an update to the user device (e.g., to update the network security settings) to (i) cause an update at the user device and (ii) correct the service impact error. In this way, the system can proactively correct service impact errors remotely, thereby enhancing the user experience and enhancing user device connectivity to telecommunications networks.

At act 310, process 300 can transmit a message indicating the cause of the service impact error. For example, the system can transmit a message indicating the cause of the service impact error to each user device of the set of user devices (e.g., identified in act 308). For instance, upon determining the cause (e.g., the type of cause of the service impact error, the cause of the service impact error, etc.), the system may generate a message, such as a notification, email, text message, or other message that includes the cause of the service impact error. The system can then transmit the generated message to each user device of the set of user devices to proactively notify users of such devices of a reason for the service impact error. As the message actively notifies users of such service impact errors, the telecommunications network may provide transparency as to the errors experienced within the telecommunications network, thereby improving the user experience.

In some implementations, the system can transmit a message to user devices that communicate with base stations associated with the service impact error. For example, the system can determine, for each user device of the set of user devices that communicate with a set of base stations, a home base station that a user device communicates with. For instance, the system may store information (e.g., in a database) indicating which base stations user devices regularly communicate with (e.g., a home base station). The home base station can be referred to a base station that provides cellular or satellite network coverages within a specific location (e.g., a home address of a user of the user device, an office location of the user of the user device, etc.). The home base station may provide cellular/satellite network coverage to the user device for a time period that is greater than other time periods of other base stations.

To provide proactive notifications as to service impact errors that may impact the QoS between user devices and a telecommunications network/service, the system can determine what base stations are home base stations for a set of user devices. If a home base station is impacted by a service impact error, the system can generate a message indicating the service impact error, and transmit the message to each user device that has the impacted base station as their home base station. In this way, the system can notify users that there is a current service impact error that may impact telecommunications network services to their user device, thereby enhancing the user experience.

In one use case, where a given base station is impacted by a service impact error, the system can determine which user devices use the base station as their home base station. For instance, the system can parse a database storing home base station information (e.g., including a mapping of user device identifiers to home base station identifiers) to determine which base stations are home base stations to given user devices. The system can then generate and transmit a message to each user device that is associated with the impacted home base station that indicates that a service impact error is impacting their home base station. For example, where the home base station for a user device is a base station located proximate to the user's home address, the system can generate a message indicating that network speeds may lag at their home address due to the service impact error (or other message). In this way, users can be notified of service impact errors when they are communicating with other remote base stations (e.g., that are not their home base stations), thereby improving telecommunications connectivity services.

### Computer System

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computer system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computer system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computer system 500 to mediate data in a network 514 with an entity that is external to the computer system 500 through any communication protocol supported by the computer system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computer system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computer system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

We claim:

1. A system for improving telecommunications network resource connectivity via proactive telecommunications network error detection, the system comprising:
at least one hardware processor; and
at least one non-transitory memory storing instructions, which, when executed by the at least one hardware processor, cause the system to:
receive an automatically-triggered message indicating a telecommunications service impact error impacting a quality of service between a mobile device and a telecommunications network, wherein the message comprises (i) a mobile device identifier and (ii) a telecommunications service impact error identifier;
responsive to receiving the message indicating the telecommunications service impact error, access a set of connectivity logs to determine a set of telecommunications base stations associated with the telecommunications service impact error using (i) the mobile device identifier and (ii) the telecommunications service impact error identifier;
responsive to determining the set of telecommunications base stations associated with the telecommunications service impact error, access a subset of the set of connectivity logs to identify a type of cause of the telecommunications service impact error, wherein the subset of the set of connectivity logs are associated with the determined set of telecommunications base stations, and wherein the type of cause comprises at least one of a network type cause or a mobile device type cause of the telecommunications service impact error;
determine, a set of mobile devices that were in communication with each base station of the set of telecommunications base stations during a first time period, using the subset of the set of connectivity logs;
transmit a message indicating the type of cause of the telecommunications service impact error to each mobile device of the set of mobile devices; and
in response to the type of cause of the telecommunications service impact error being the network type cause, deploy one or more network resources to correct the telecommunications service impact error.

2. The system of claim 1, wherein the automatically-triggered message is received from the mobile device in response to the mobile device detecting the telecommunications service impact error relative to a base station of the set of telecommunications base stations.

3. The system of claim 1, wherein the automatically-triggered message is received in response to a given base station of the set of telecommunications base stations that the mobile device was connected to detecting the telecommunications service impact error.

4. The system of claim 1, further comprising:
determining that the cause of the telecommunications service impact error is the mobile device type cause using the subset of the set of connectivity logs; and
in response to determining that the cause of the telecommunications service impact error is the mobile device type cause, transmitting a second message indicating an update instruction to the mobile device to cause an update at the mobile device.

5. A method for improving telecommunications network resource connectivity via proactive telecommunications network error detection, the method comprising:
receiving a triggered message indicating a service impact error impacting a quality of service between a user device and a telecommunications network, wherein the message comprises (i) a user device identifier and (ii) a service impact error identifier;
responsive to receiving the message indicating the service impact error, accessing a set of connectivity artifacts to determine a set of telecommunications components associated with the service impact error using the triggered message;
responsive to determining the set of telecommunications components associated with the service impact error, accessing a subset of the set of connectivity artifacts to identify a cause of the service impact error;
determining a set of user devices that communicate with any of the set of telecommunications components during a first time period, using the subset of the set of connectivity artifacts; and
transmitting a message indicating the cause of the service impact error to each user device of the set of user devices.

6. The method of claim 5, wherein the triggered message is received from the user device in response to the user device detecting the service impact error relative to at least one of the set of telecommunications components.

7. The method of claim 5, wherein the triggered message is received in response to a given telecommunications component of the set of telecommunications components that the user device was communicating with detecting the service impact error.

8. The method of claim 5, further comprising:
detecting that a quality criterion associated with a communication session associated with a user device and the telecommunications network fails to satisfy a threshold quality criterion; and
responsive to detecting that the quality criterion fails to satisfy the threshold quality criterion, generating the triggered message.

9. The method of claim 5, further comprising:
determining that the cause of the service impact error is a network type cause using the subset of the set of connectivity artifacts;
responsive to determining that the cause of the service impact error is a network type cause, deploying one or more network resources to correct the service impact error; and
responsive to correcting the service impact error, transmitting a second message to each user device of the set of user devices indicating that the service impact error is corrected.

10. The method of claim 5, further comprising:
determining that the cause of the service impact error is a user device type cause using the subset of the set of connectivity artifacts; and
responsive to determining that the cause of the service impact error is the user device type cause, transmitting a second message indicating an update instruction to user device to cause an update at the user device.

11. The method of claim 5, wherein the set of telecommunications components associated with the service impact error comprises a set of base stations.

12. The method of claim 11, further comprising:
for each user device of the set of user devices that communicate with the set of base stations, determining a first base station that a first user device of the set of user devices communicate with; and
transmitting a second message to the first user device that communicates with the first base station, wherein the second message indicates the service impact error.

13. The method of claim 5, wherein identifying the cause of the service impact error further comprises:
providing the set of connectivity artifacts to a machine learning model configured to generate a cause of the service impact error; and
responsive to providing the set of connectivity artifacts to the machine learning model, generating, via the machine learning model, the cause of the service impact error, using the set of connectivity artifacts, wherein the cause of the service impact error indicates (i) a type of cause of the service impact error and (ii) a telecommunications component of the set of telecommunications components that caused the service impact error.

14. At least one non-transitory, computer-readable storage medium storing instructions, which, when executed by at least one data processor of a system, cause the system to:
receiving a triggered message indicating a service impact error impacting a quality of service between a user device and a telecommunications network, wherein the message comprises (i) a user device identifier and (ii) a service impact error identifier;
responsive to receiving the message indicating the service impact error, accessing a set of connectivity artifacts to determine a set of telecommunications components associated with the service impact error using the triggered message;
responsive to determining the set of telecommunications components associated with the service impact error, accessing a subset of the set of connectivity artifacts to identify a cause of the service impact error;
determining, a set of user devices that communicate with any of the set of telecommunications components during a first time period, using the subset of the set of connectivity artifacts; and
transmitting a message indicating the cause of the service impact error to each user device of the set of user devices.

15. The non-transitory, computer-readable storage medium of claim 14, wherein the triggered message is received from the user device in response to the user device detecting the service impact error relative to at least one of the set of telecommunications components.

16. The non-transitory, computer-readable storage medium of claim 14, wherein the triggered message is received in response to a given telecommunications component of the set of telecommunications components that the user device was communicating with detecting the service impact error.

17. The non-transitory, computer-readable storage medium of claim 14, wherein the system is further caused to:
detect that a quality criterion associated with a communication session associated with user device and the telecommunications network fails to satisfy a threshold quality criterion; and
responsive to detecting that the quality criterion fails to satisfy the threshold quality criterion, generating the triggered message.

18. The non-transitory, computer-readable storage medium of claim 14, wherein the system is further caused to:
determine that the cause of the service impact error is a network type cause using the subset of the set of connectivity artifacts;
responsive to determining that the cause of the service impact error is a network type cause, deploying one or more network resources to correct the service impact error; and
responsive to correcting the service impact error, transmitting a second message to each user device of the set of user devices indicating that the service impact error is corrected.

19. The non-transitory, computer-readable storage medium of claim 14, wherein the system is further caused to:
determine that the cause of the service impact error is a user device type cause using the subset of the set of connectivity artifacts; and
responsive to determining that the cause of the service impact error is the user device type cause, transmitting a second message indicating an update instruction to user device to cause an update at the user device.

20. The non-transitory, computer-readable storage medium of claim 14, wherein identifying the cause of the service impact error further comprises:
provide the set of connectivity artifacts to a machine learning model configured to generate a cause of the service impact error; and
responsive to providing the set of connectivity artifacts to the machine learning model, generate, via the machine learning model, the cause of the service impact error, using the set of connectivity artifacts, wherein the cause of the service impact error indicates (i) a type of cause of the service impact error and (ii) a telecommunications component of the set of telecommunications components that caused the service impact error.
